(19) United States
(12) Patent Application Publication
(10) Pub. No.: US 2010/0297527 A1
(43) Pub. Date: Nov. 25, 2010

(54) Fast Ion Conducting Composite Electrolyte for Solid State Electrochemical Devices

(75) Inventors: Timothy R. Armstrong, Clinton, TN (US); Beth L. Armstrong, Clinton, TN (US); John J. Henry, JR., Knoxville, TN (US)

Correspondence Address: UT-Battelle, LLC;Office of Intellectual Property, One Bethal Valley Road, 4500N, MS-6258, Oak Ridge, TN, 37831, US

(73) Assignee: UT-BATTELLE, LLC, Oak Ridge, TN (US)

(21) Appl. No.: 12/695,181

(22) Filed: Jan. 28, 2010

Related U.S. Application Data
(60) Provisional application No. 61/179,513, filed on May 19, 2009.

(51) Int. Cl. H01M 8/10

(52) U.S. Cl. 429/491

(57) ABSTRACT

Composite electrolyte materials include composites comprising 8YSZ in a range of 50-95%, balance 3YSZ. Either the 8YSZ or the 3YSZ can be substituted with a composition having the general formula A_{1-x-y}BₓC_{y} where: A=Zr_{0.84}Y_{0.16}O₂; B=at least one of the following: Zr₁₋ₓDₓO₂ where: D=at least one of the group Mg, Ca, Sc, and Y, and x=0.03 to 0.16; and Ce₁₋ₓREₓO₂ where: RE=at least one rare-earth element and x=0.05 to 0.20; C=Al₂O₃ where y=0 to 0.20. The composite electrolyte materials are useful in solid state electrochemical devices such as solid oxide fuel cells and electrolyzers.

### CROSS-REFERENCE TO RELATED APPLICATIONS

This application claims the benefit of U.S. Provisional Application No. 61/179,513 filed on May 19, 2009, the entire disclosure of which is incorporated herein by reference.

U.S. patent application Ser. No. 11/755,945 entitled “Solid Oxide Fuel Cell Having Internal Active Layers” filed on May 31, 2007 by Timothy R. Armstrong, Roddie R. Judkins, Beth L. Armstrong, and Brian L. Bischoff is specifically referenced and incorporated herein by reference.

### STATEMENT REGARDING FEDERALLY SPONSORED RESEARCH

The United States Government has rights in this invention pursuant to contract no. DE-AC05-00OR22725 between the United States Department of Energy and UT-Battelle, LLC.

### NAMES OF PARTIES TO A JOINT RESEARCH AGREEMENT

This invention arose under Cooperative Research and Development Agreement No. ORNL-0720.0 between UT-Battelle, LLC and Worldwide Energy, Inc.

### BACKGROUND OF THE INVENTION

Solid state electrochemical devices are well known in the art and include devices such as solid oxide fuel cells, electrolyzer cells, and the like. Devices commonly known as fuel cells comprise arrays of plates or tubes that directly convert to electricity (electric power) the energy released by oxidation of hydrogen. Simplistically, a fuel cell unit comprises layers, including an anode, a cathode, and an oxygen-permeable, dense electrolyte layer therebetween. Often such layers are supported by a rigid metal, ceramic, or cermet substrate.

Solid oxide fuel cell (SOFC) fabrication often involves co-sintering an electrolyte layer and a rigid support, which can be difficult due to differential shrinkage of the component materials, resulting in cracking, warping, delamination, breakage, and other forms of physical failure. Some examples of SOFCs are annular in shape, and are commonly referred to as tubular solid oxide fuel cells (TSOFC). In these types of SOFCs the active layers (anode, dense electrolyte, and cathode) may be placed on a porous metal support tube to complete the SOFC element. Other examples of SOFC are planar in shape where individual fuel cell elements are flat sandwiched layers of various materials comprising anode, dense electrolyte, and cathode.

### BRIEF DESCRIPTION OF THE DRAWINGS

FIG. 1 is an oblique, not-to-scale view of a portion of a TSOFC in accordance with an example of the present invention.

FIG. 2 is an oblique, not-to-scale view of a portion of a TSOFC in accordance with an example of the present invention.

FIG. 3 is an oblique, not-to-scale view of a portion of a TSOFC in accordance with an example of the present invention.

FIG. 4 is an oblique, not-to-scale view of a portion of a TSOFC in accordance with an example of the present invention.

FIG. 5 is an oblique, not-to-scale view of a portion of a SOFC tube sheet in accordance with an example of the present invention.

FIG. 6 is an oblique, not-to-scale view of a portion of a SOFC tube sheet in accordance with an example of the present invention.

FIG. 7 is a graph showing percent theoretical density achieved using 3YSZ, 8YSZ, and 10YSZ.

FIG. 8 is a graph showing percent theoretical density achieved using composites of 3YSZ and 8YSZ in accordance with some examples of the present invention.

FIG. 9 is a scanning electron micrograph of a SOFC support tube section coated with porous and dense 8YSZ layers.

For a better understanding of the present invention, together with other and further objects, advantages and capabilities thereof, reference is made to the following disclosure and appended claims in connection with the above-described drawings.

### DETAILED DESCRIPTION OF THE INVENTION

The present invention is applicable to any configuration and/or shape of solid state electrochemical devices, including tubular, planar, tube sheet, etc. Representative examples are described herein with respect to a SOFC device.

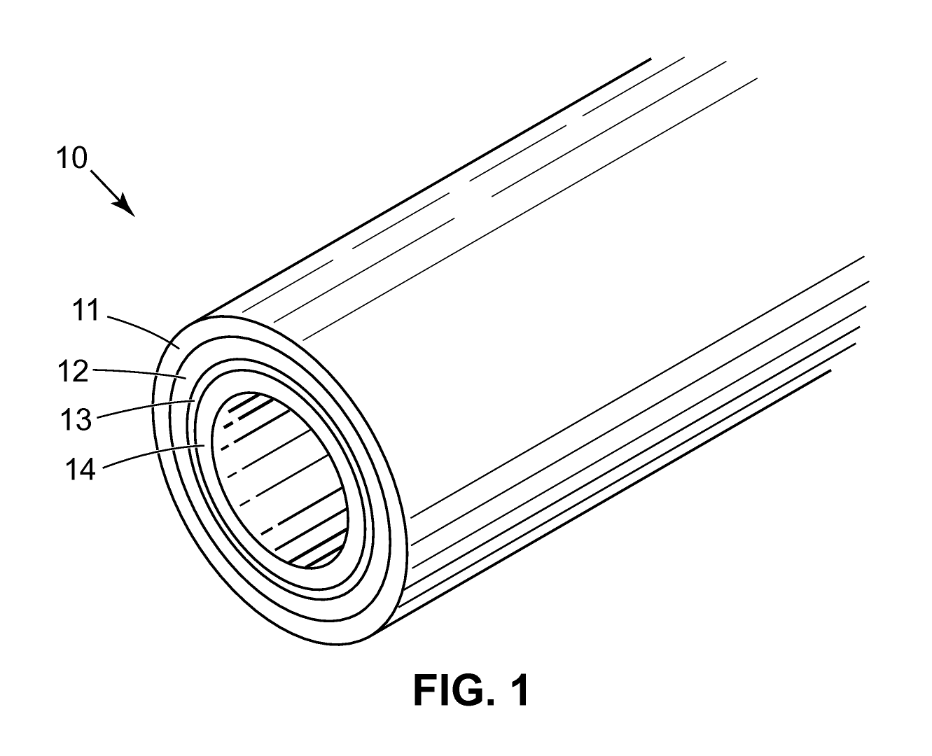

Referring to FIG. 1 in a basic embodiment, the invention begins with a porous support component such as, for example, a tube 11 that may comprise any porous, sinterable material selected from the group consisting of a non-noble transition metal, metal alloy, and a cermet incorporating one or more of a non-noble transition metal and a non-noble transition metal alloy, preferably a stainless steel, and more preferably a ferritic and/or austenitic stainless steel. The support tube 11 can be of any diameter or length and it should be electrically conductive at all operating temperatures. Wall thickness thereof can be, for example, about 5 mm or less. Moreover, the support can, for example, have an average pore size in the range of 1 to 300 μm. Moreover, the support can, for example, have an average pore volume in the range of 10 to 70 volume percent. The support tube 11 can be formed in any suitable cross-sectional shape, including circular, elliptical, triangular, rectangular, irregular, or any other desired shape. A round shape, especially an essentially circular shape as shown in FIG. 1, accommodates uniform deposition of layers on the inner surface of the support tube 11.

The porous support tube 11 may be prepared by conventional powder metallurgy techniques, such as molding, extrusion, casting, forging, isostatic compression, etc. The support tube 11 should be open on both ends.

Referring to FIG. 1, in accordance with an example of the present invention, active fuel cell membrane layers are deposited as layers 12, 13, 14 on the inside (inner) surface of the porous support tube 11 to form an annular TSOFC 10. It can be seen that each successive layer supports the layers that are subsequently deposited thereon.

The first active fuel cell membrane layer 12 is an anode material, which can be any anode material, but is preferably comprised of a cermet composition. Examples of suitable cermet compositions include, but are not limited to Ni—YSZ, Ni—GdCeO₂, Ni—SmCeO₂, and Ag—SmCeO₂. Anode thickness can be, for example, in a range of 3-100 μm. The anode can, for example, have an average pore size of0.3-50 μm and pore volume of 15-60 volume percent. The anode 12 is applied to the support tube 11 by a conventional method such as sol-gel, slurry, or wash coating, for example. The anode 12 can be sintered before or after the application of subsequent layers.

The next active fuel cell membrane layer 13 is a non-porous and/or operably dense O₂-permeable or H₂-permeable electrolyte composition. The terms “operably dense” and “operable density” as used herein mean that the electrolyte layer is sufficiently dense to be used in a fuel cell or electrolyzer, with minimal or no leakage of reactants therethrough. The skilled artisan will recognize that the terms “fully dense” and “full density” are also interpreted to have like meaning

Conventional electrolytes such as Yttria stabilized zirconia (YSZ) (>8 mole percent Y₂O₃ in ZrO₂) and Gadolinium stabilized ceria (GSC) (>5 mole percent Gd₂O₃ in CeO₂) require sintering temperatures in excess of 1300° C. for attain operable density (i.e., closed porosity). In accordance with the present invention, composite electrolytes comprised of mixtures of electrolytes and other oxides can be sintered to operable density at temperatures significantly less than 1300° C., minimizing the above-described differential shrinkage and low porosity of the final product, while allowing an operably dense electrolyte to be obtained. Moreover, a number of fast ion conducting oxides can be substituted into the compositions as described hereinbelow. Such substitutions can beneficially allow processing conditions to be tailored to match that of any support material used.

The electrolyte can, for example, have a thickness in a range of 2-300 μm. The electrolyte should be operably dense and gas tight to prevent the air and fuel from mixing. The electrolyte layer 13 may be deposited using a conventional method such as sol-gel, slurry, or wash coating, for example, and subsequently sintered.

The first two layers 12, 13 can be sintered simultaneously under either neutral (neutral as used herein means neither oxidizing nor reducing) or reducing conditions so that the anode maintains or attains the characteristics described hereinabove while achieving full densification of the electrolyte layer. The sintered electrolyte is preferably at least operably dense and essentially defect-free. Sintering parameters can include, for example, a temperature range of 1200-1300° C., preferably less than 1300° C., and a duration of 0.2 to 6 hours, usually about 1 to 2 hours.

The final layer is the cathode 14, which is generally comprised of alkaline earth substituted lanthanum manganite, alkaline earth substituted lanthanum ferrite, lanthanum strontium iron cobaltite, or a mixed ionic-electronic conductor, but the composition of the cathode 14 is not critical to the invention. The cathode 14 thickness can, for example, be in a range of 5-300 μm. The cathode 14 can, for example, have an average pore size of 0.3-50 μm and pore volume of 15-60 volume percent. The cathode 14 can also be deposited using a conventional method such as sol-gel, slurry, or wash coating, for example.

The final step is a sintering process that is composed of heating the entire TSOFC 10 in a neutral or reducing environment to 1000-1300° C., preferably less than 1300° C. for a duration of 0.2 to 6 hours, usually about 1 to 2 hours, depending on the cathode material used. The term neutral as used herein means neither oxidizing nor reducing.

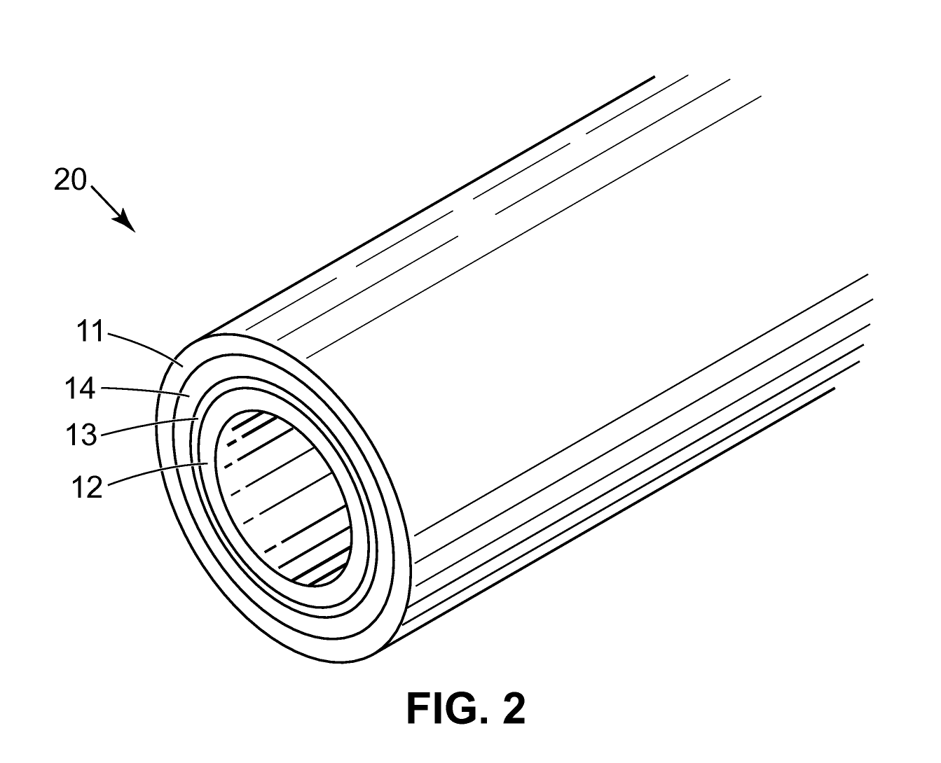

Referring to FIG. 2, in accordance with an example of the present invention, a TSOFC 20 can have the internal active layers deposited on the inside surface of the support tube 11 in reverse order (14, 13, 12). The skilled artisan will recognize that the fuel and oxygen supplies will also need to be reversed in operation.

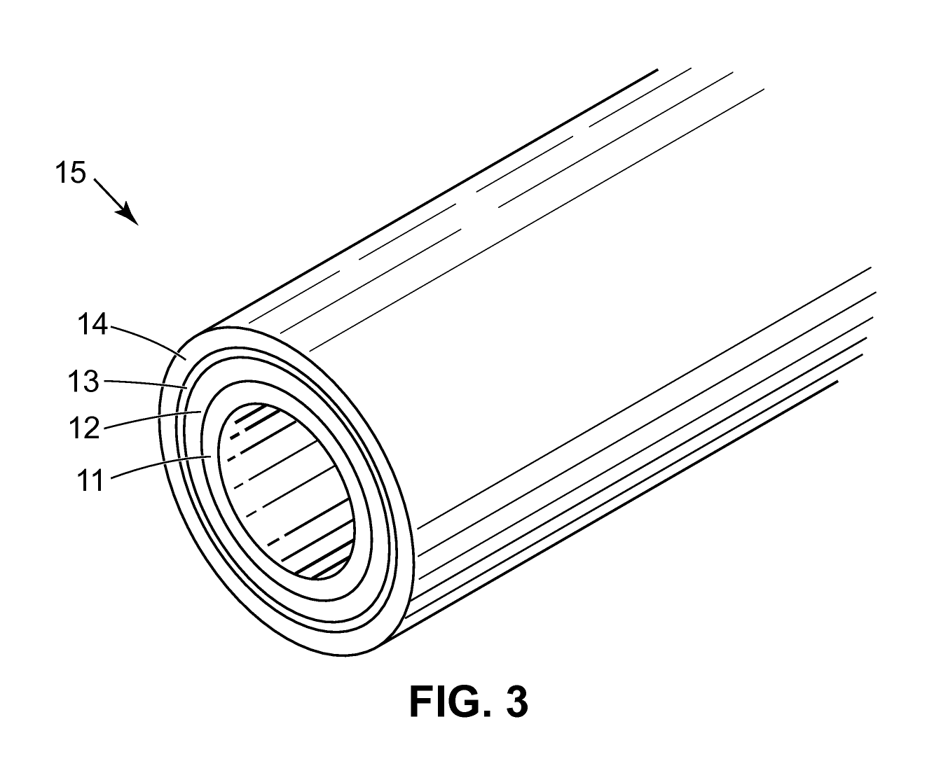

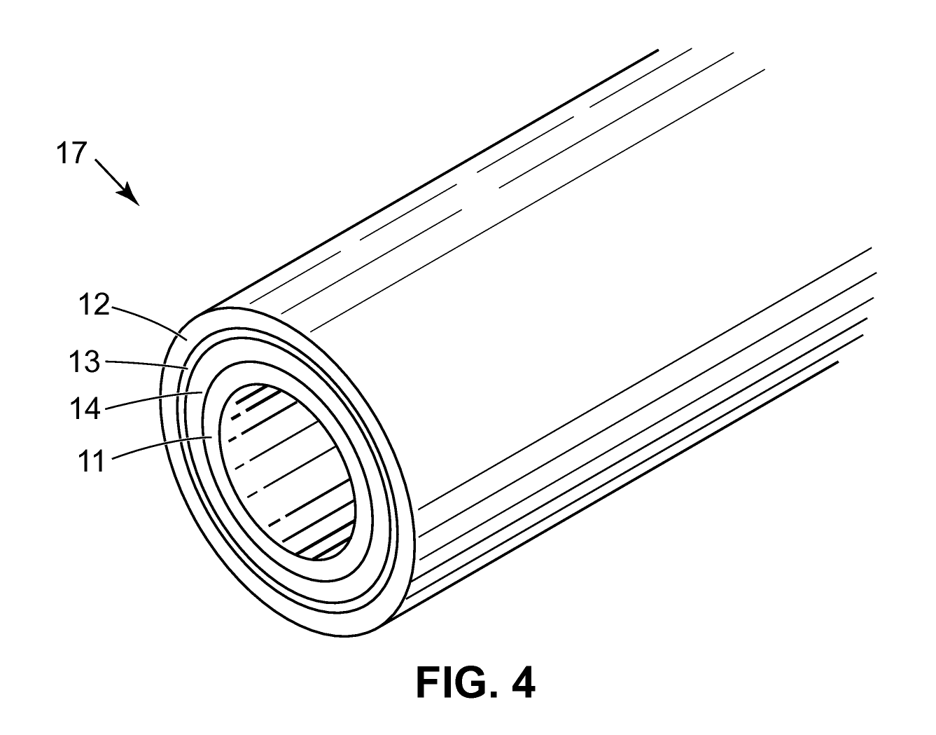

Referring to FIGS. 3, 4, in other examples of the present invention, the active layers can be deposited on the outer surface of the support tube 11 in either order (12, 13, 14) or (14, 13, 12), respectively.

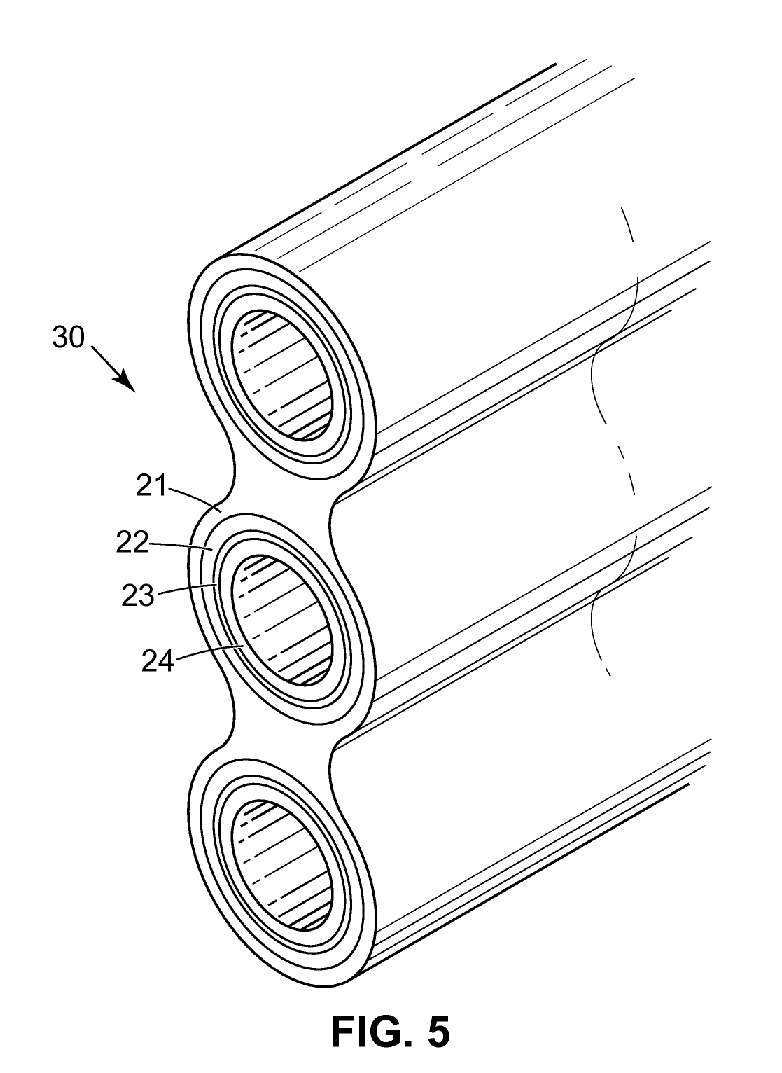

Referring to FIG. 5, in some accordance with the present invention, active fuel cell membrane layers can be deposited and sintered as described hereinabove to form a SOFC tube sheet 30. Each inner surface of the tube sheet 21 is coated on the inside thereof with a porous anode 22 such as Ni—YSZ, for example. The anode 22 is coated on the inside with a dense electrolyte 23 such as Y₂O₃—ZrO₂, for example. The dense electrolyte 23 is coated on the inside with a porous cathode 24 such as LaMnO₃, for example. It can be seen that each successive layer supports the layers that are subsequently deposited thereon.

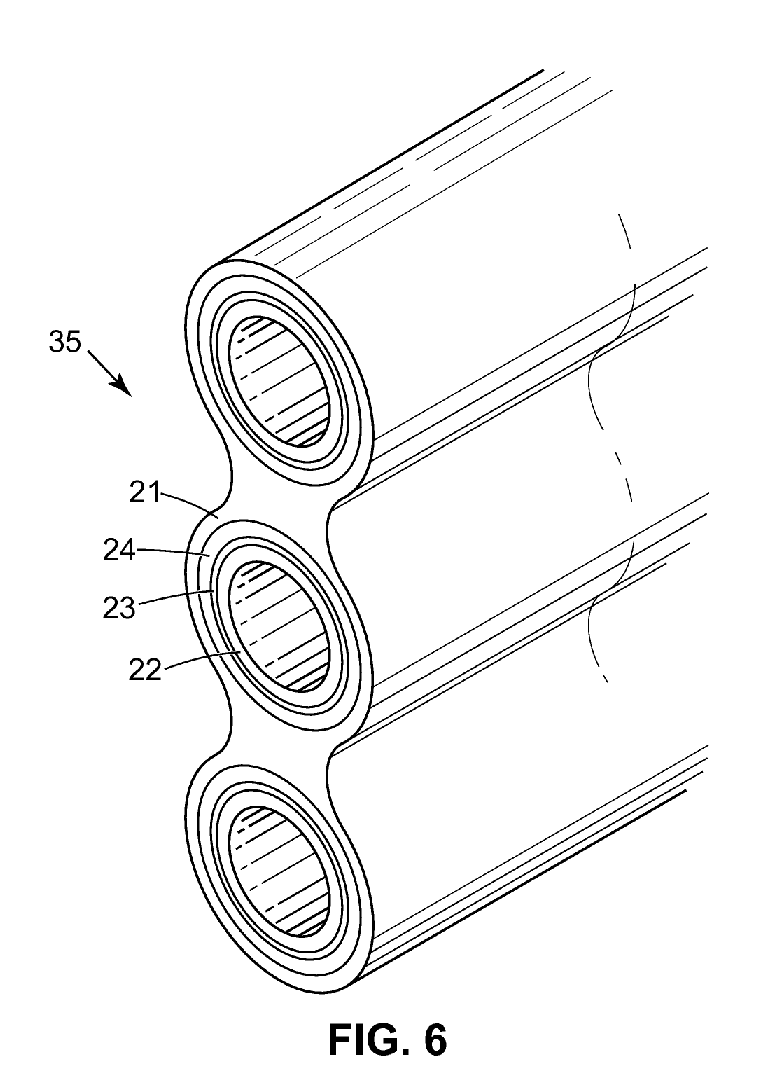

Referring to FIG. 6, in some embodiments of the present invention, a TSOFC tube sheet 35 can have the internal active layers deposited on the inside of the tube sheet 21 in reverse order (24, 23, 22). The skilled artisan will recognize that the fuel and oxygen supplies will also need to be reversed in operation.

In some accordance with the present invention, active fuel cell membrane layers can be deposited and sintered as described hereinabove in a planar support to form a planar SOFC. The skilled artisan will recognize that any shape and configuration of the support can be employed to make any desired shape and configuration SOFC.

For the sintering steps described hereinabove, sintering temperatures below 1300° C. are desirable in order to minimize interdiffusion of electrolyte layers with other layers of a SOFC structure. Moreover, a sintering temperature below 1300° C. is desirable in order to minimize sintering, densification, and/or melting of other, non-electrolyte layers of a SOFC structure. When sintered at 1300° C., conventional SOFCs had extremely low porosity of the final SOFC element. However, for applications described herein the sintering temperature of the electrolyte needs to be reduced to less than 1300° C.

Examples of composite electrolyte materials of the present invention include composites comprising 8YSZ in a range of 50-95 wt. %, balance 3YSZ. Either the 8YSZ or the 3YSZ can be substituted with a fast ion conducting oxide having the general formula A_{1-x-y}BₓC_{y} where:
A=Zr_{0.84}Y_{0.16}O₂
B=at least one of the following:
   Zr₁₋ₓDₓO₂ where:
      D=at least one of the group Mg, Ca, Sc, and Y, and
      x=0.03 to 0.16; and
   Ce₁₋ₓREₓO₂ where:
      RE=at least one rare-earth element and
      x=0.05 to 0.20
C=Al₂O₃ where y=0 to 0.20

Examples of rare-earth elements (RE) include La, Ce, Pr, Nd, Pm, Sm, Eu, Gd, Tb, Dy, Ho, Er, Tm, Yb, and Lu.

The composites allow the sintering temperature of Zr_{0.84}Y_{0.16}O₂ to be reduced by up to 100° C. to achieve full density in thin film greater than or equal to 1 micron meter when applied by any thin film method.

### EXAMPLE I

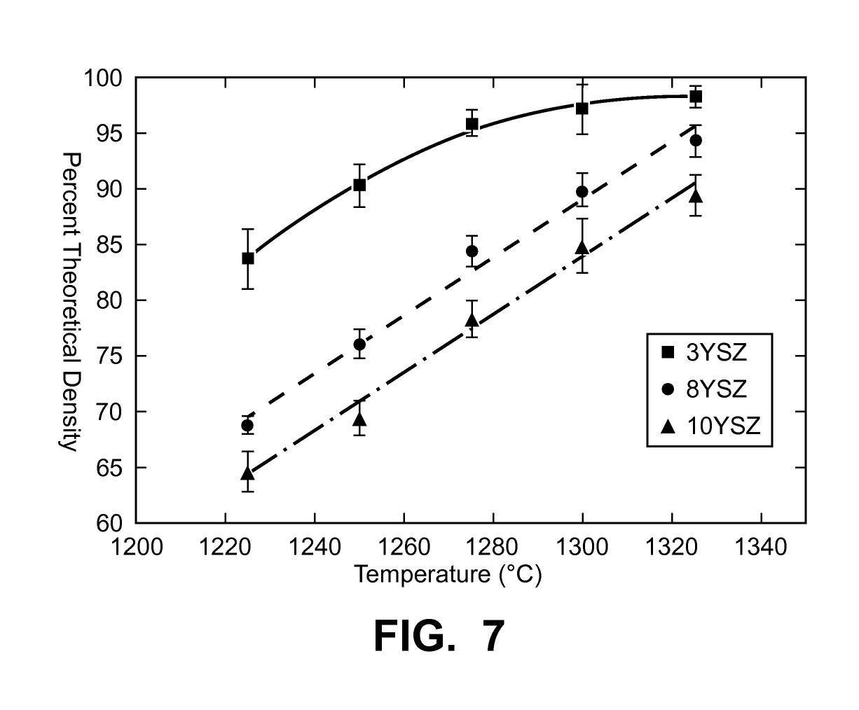

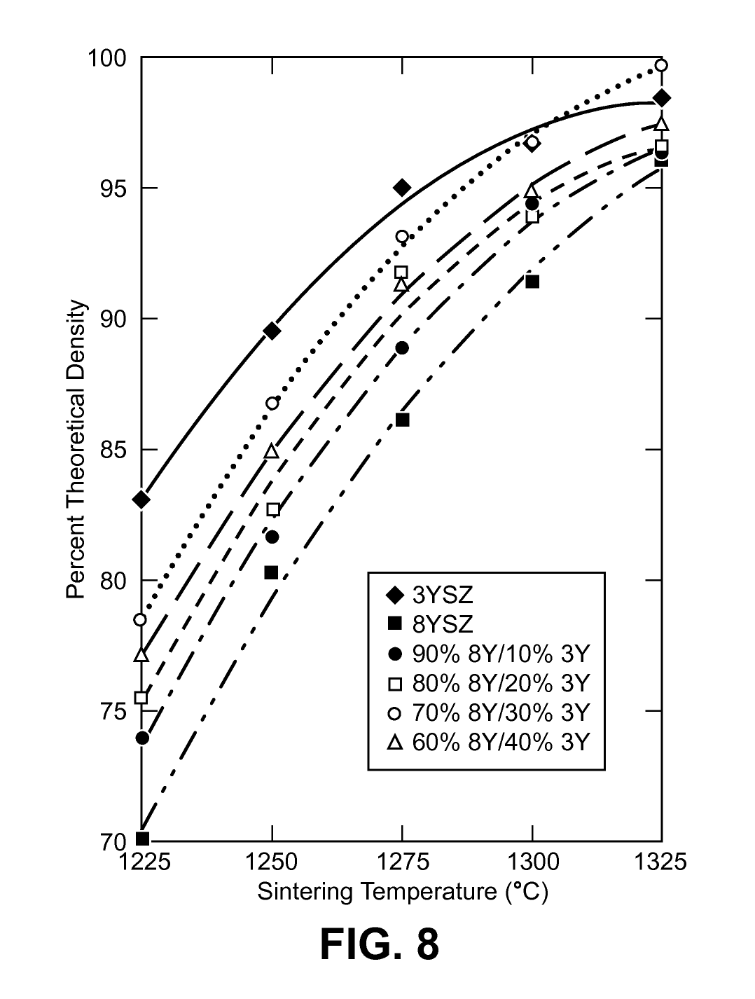

In order to test various contemplated electrolyte formulations, 3YSZ powder, 8YSZ powder, 10YSZ powder, and mixtures of 3YSZ powder and 8YSZ powder were prepared in the following percentages: 90% 8YSZ/10% 3YSZ, 80% 8YSZ/20% 3YSZ, 70% 8YSZ/30% 3YSZ, and 60% 8YSZ/40% 3YSZ. Each of the mixtures was pressed into a pellet using a uniaxial die, followed by isostatic pressing of the pellet to increase green density. The resulting pellets were sintered for 1 hour at temperatures shown in FIGS. 7, 8. Densities of the pellets were subsequently measured geometrically and by the Archimedes methods. The data in FIG. 8 show comparative formulations, sintering temperatures, and densities, enabling optimization of sintering temperatures and densities of solid state electrochemical devices, for example, by finding the maximum density at the lowest sintering temperature, in accordance with the present invention.

Alternatively, formulation and heat treatment temperatures can be altered to be able to process at other temperature conditions or achieve different properties, such as mechanical strength or conductivity.

### EXAMPLE II

A powder mixture comprising 70% 8YSZ/30% 3YSZ is combined with appropriate conventional solvent and dispersant and mixed in a ball mill. The resulting slurry is used to coat surface of a SOFC with green electrolyte coating during manufacture as described hereinabove. The coated SOFC is sintered at 1273° C. for 1 hour in Ar—4% H₂ to a density of 93% theoretical density.

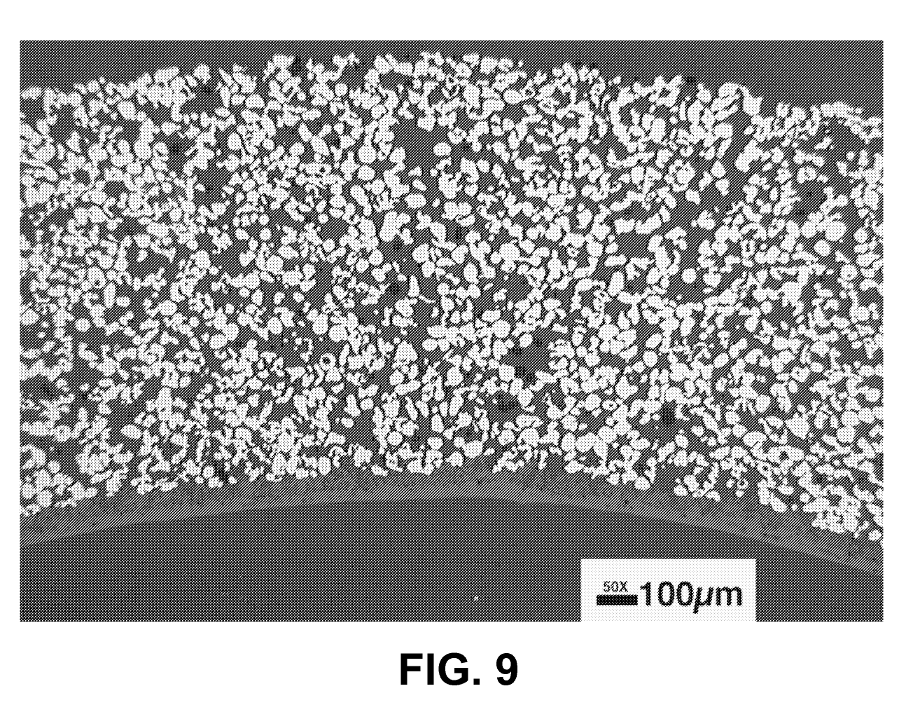

As an example of the desired density that may be achieved in practicing the present invention, FIG. 9 shows a scanning electron micrograph of #1699 434L tube section (Large, porous region) coated on the inside with porous and dense 8YZ layers (thin, darker regions) and sintered at 1300° C. for 1 hour in Ar—4% H₂.

The skilled artisan will recognize that, for additional coating process functionalities, coating green strength, and/or final product properties, at least one optional, conventional binder, dispersant, plasticizer, and/or rheology modifier can be added to the mixtures.

While there has been shown and described what are at present considered to be examples of the invention, it will be obvious to those skilled in the art that various changes and modifications can be prepared therein without departing from the scope of the inventions defined by the appended claims.

What is claimed is:

1. A composite electrode comprising 8YSZ in a range of 50-95 wt. %, balance 3YSZ.

2. A composite electrode comprising 8YSZ in a range of 50-95 wt. %, balance comprising a composition having the general formula A_{1-x-y}BₓC_{y} where:
A=Zr_{0.84}Y_{0.16}O₂
B=at least one component selected from the group consisting of:
Zr₁₋ₓDₓO₂ where:
D=at least one element selected from the group consisting of: Mg, Ca, Sc, and Y, and
x=0.03 to 0.16; and
Ce₁₋ₓREₓO₂ where:
RE=at least one rare earth element selected from the group consisting of:
La, Ce, Pr, Nd, Pm, Sm, Eu, Gd, Tb, Dy, Ho, Er, Tm, Yb, and Lu, and
x=0.05 to 0.20
C=Al₂O₃ where y=0 to 0.20

3. A composite electrode comprising 3YSZ in a range of 5-50 wt. %, balance comprising a composition having the general formula A_{1-x-y}BₓC_{y} where:
A=Zr_{0.84}Y_{0.16}O₂
B=at least one component selected from the group consisting of:
Zr₁₋ₓDₓO₂ where:
D=at least one element selected from the group consisting of: Mg, Ca, Sc, and Y, and
x=0.03 to 0.16; and
Ce₁₋ₓREₓO₂ where:
RE=at least one rare earth element selected from the group consisting of: La, Ce, Pr, Nd, Pm, Sm, Eu, Gd, Tb, Dy, Ho, Er, Tm, Yb, and Lu, and
x=0.05 to 0.20
C=Al₂O₃ where y=0 to 0.20

4. A solid state electrochemical device comprising a support component and a composite electrolyte layer supported thereby, said composite electrolyte layer comprising 8YSZ in a range of 50-95 wt. %, balance 3YSZ.

5. A solid state electrochemical device in accordance with claim 4 further comprising a cathode layer supported by said support component.

6. A solid state electrochemical device in accordance with claim 4 further comprising an anode layer supported by said support component.

7. A solid state electrochemical device in accordance with claim 4 wherein said support component and a composite electrolyte layer comprise a solid oxide fuel cell.

8. A solid state electrochemical device in accordance with claim 4 wherein said support component comprises at least one of the group consisting of a tube, a tube sheet, and a planar component.

9. A solid state electrochemical device comprising a support component and a composite electrolyte layer supported thereby, said composite electrolyte layer comprising 8YSZ in a range of 50-95 wt. %, balance comprising a composition having the general formula A_{1-x-y}BₓC_{y} where:
A=Zr_{0.84}Y_{0.16}O₂
B=at least one component selected from the group consisting of:
Zr₁₋ₓDₓO₂ where:
D=at least one element selected from the group consisting of: Mg, Ca, Sc, and Y, and
x=0.03 to 0.16; and
Ce₁₋ₓREₓO₂ where:
RE=at least one rare earth element selected from the group consisting of: La, Ce, Pr, Nd, Pm, Sm, Eu, Gd, Tb, Dy, Ho, Er, Tm, Yb, and Lu, and
x=0.05 to 0.20
C=Al₂O₃ where y=0 to 0.20

10. A solid state electrochemical device in accordance with claim 9 further comprising a cathode layer supported by said support component.

11. A solid state electrochemical device in accordance with claim 9 further comprising an anode layer supported by said support component.

12. A solid state electrochemical device in accordance with claim 9 wherein said support component and a composite electrolyte layer comprise a solid oxide fuel cell.

13. A solid state electrochemical device in accordance with claim 9 wherein said support component comprises at least one of the group consisting of a tube, a tube sheet, and a planar component.

14. A solid state electrochemical device comprising a support component and a composite electrolyte layer supported thereby, said composite electrolyte layer comprising 3YSZ in a range of 5-50 wt. %, balance comprising a composition having the general formula A_{1-x-y}BₓC_{y} where:
A=Zr_{0.84}Y_{0.16}O₂
B=at least one component selected from the group consisting of:
Zr₁₋ₓDₓO₂ where:
D=at least one element selected from the group consisting of: Mg, Ca, Sc, and Y, and
x=0.03 to 0.16; and
Ce₁₋ₓREₓO₂ where:
RE=at least one rare earth element selected from the group consisting of: La, Ce, Pr, Nd, Pm, Sm, Eu, Gd, Tb, Dy, Ho, Er, Tm, Yb, and Lu, and
x=0.05 to 0.20
C=Al₂O₃ where y=0 to 0.20

15. A solid state electrochemical device in accordance with claim 14 further comprising a cathode layer supported by said support component.

16. A solid state electrochemical device in accordance with claim 14 further comprising an anode layer supported by said support component.

17. A solid state electrochemical device in accordance with claim 14 wherein said support component and a composite electrolyte layer comprise a solid oxide fuel cell.

18. A solid state electrochemical device in accordance with claim 14 wherein said support component comprises at least one of the group consisting of a tube, a tube sheet, and a planar component.
